(19) United States
(12) Patent Application Publication
(10) Pub. No.: US 2011/0011155 A1
(43) Pub. Date: Jan. 20, 2011

(54) PROCESS FOR ANALYZING LOW MOLECULAR WEIGHT ORGANIC COMPOUND HAVING AT MOST 20 CARBON ATOMS IN CLOTH MADE OF CHEMICAL FIBERS TREATED WITH WATER AND OIL REPELLENT AGENT

(75) Inventors: Satoshi HIKIMA, Tokyo (JP); Satoshi Fujita, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Tokyo (JP)

(21) Appl. No.: 12/889,534

(22) Filed: Sep. 24, 2010

Related U.S. Application Data
(63) Continuation of application No. PCT/JP09/62254, filed on Jun. 30, 2009.

(30) Foreign Application Priority Data
Jun. 30, 2008 (JP) 2008-171204

(51) Int. Cl. G01N 30/02; B01D 59/44; G01N 30/00

(52) U.S. Cl. 73/23.37; 73/61.52; 250/282

(57) ABSTRACT

To provide a process, whereby a low molecular weight organic compound having at most 20 carbon atoms present in a trace amount in a cloth made of chemical fibers treated with a water and oil repellent agent, can be accurately analyzed.

A process for analyzing a low molecular weight organic compound having at most 20 carbon atoms in a cloth made of chemical fibers treated with a water and oil repellent agent, which comprises (a) a step of dissolving the cloth made of chemical fibers treated with a water and oil repellent agent in a solvent capable of dissolving a resin constituting the cloth, to obtain a solution, (b) a step of mixing the solution with a solvent capable of agglomerating the resin to agglomerate the resin, to obtain a liquid containing a resin agglomerate, (c) a step of subjecting the liquid containing a resin agglomerate to solid-liquid separation to obtain a liquid phase, and (d) a step of measuring the concentration of a low molecular weight compound having at most 20 carbon atoms in the liquid phase by means of a liquid chromatograph-mass spectrometer, a liquid chromatograph-tandem mass spectrometer, a gas chromatograph-mass spectrometer or a gas chromatograph-tandem mass spectrometer.

### TECHNICAL FIELD

The present invention relates to a process for analyzing a low molecular weight organic compound having at most 20 carbon atoms in a cloth made of chemical fibers treated with a water and oil repellent agent.

### BACKGROUND ART

It has been common practice to treat an article (such as a fiber product or a paper product) with a water and oil repellent agent containing a fluoropolymer having repeating units based on a compound having a perfluoroalkyl group, to impart water and oil repellency to the surface of the article.

Recently, it has been found that perfluorooctanoic acid (hereinafter referred to as PFOA) or perfluorooctane sulfonic acid (hereinafter referred to as PFOS) is detected in a natural or living environment (such as in bloods of wild animals or humans, or in rivers), and its risks are worried (e.g. Non-Patent Documents 1 and 2). At present, with respect to PFOA and PFOS, evaluation of risks is being carried out primarily by EPA of USA. But at present, no conclusion has been available.

On the other hand, as precursors which may form PFOA by e.g. biodegradation, (perfluorooctyl)ethyl alcohol, (perfluorooctyl)ethyl iodide (perfluorooctyl)ethene and perfluorooctyl iodide (hereinafter they may be generally referred to as PFOA precursors) may be mentioned. Also with respect to PFOA precursors, risks are likewise worried.

It is known that PFOA, PFOS and PFOA precursors may sometimes be contained in the above-mentioned water and oil repellent agent in a trace amount as unintended impurities. Therefore, it has been attempted to develop a water and oil repellent free from PFOA, PFOS and PFOA precursors, and accordingly, it is desired to establish a process for analyzing PFOA, PFOS and PFOA precursors in a water and oil repellent agent and in a cloth treated with a water and oil repellent agent.

As a method for analyzing PFOA, etc. remaining in a cloth treated with a water and oil repellent agent, a solid-liquid extraction method by means of e.g. an alcohol is known (Non-Patent Document 3).

According to such a method, PFOA, etc. remaining in a cloth can accurately be quantified in a case where the cloth treated with the water and oil repellent agent is cotton. However, in a case where the cloth treated with a water and oil repellent agent is a cloth made of carbon fibers (such as nylon cloth or polyester cloth), it is not possible to accurately quantify PFOA, etc. remaining in the cloth by such a method.

Non-Patent Document 1: Hisao Nakata et al., “Development of Simultaneous Analyses of Organic Fluorocompounds in Human Blood Plasma by Means of Online Solid Phase Extraction-High Performance Liquid Chromatography/Tandem Mass Spectrometer”, Analytical Chemistry, Japan Society for Analytical Chemistry, 2005, vol. 54, No. 9, p. 877-884

Non-Patent Document 2: Nobutsune Katsumata et al., “Quantitative Analysis of Perfluorocompounds in House Dust by Means of Supercritical Fluid-High Performance Liquid Chromatography/Tandem Mass Spectrometry”, Analytical Chemistry, Japan Society for Analytical Chemistry, 2006, vol. 55, No. 12, p. 955-965

Non-Patent Document 3: M. Stadalius, et al., “A method for the low-level (ng g⁻¹) determination of perfluorooctanoate in paper and textile by liquid chromatography with tandem mass spectrometry”, Journal of Chromatography A, 2006, vol. 1123, p. 10-14

### SUMMARY OF INVENTION

### Technical Problem

The present invention is to provide a process whereby a low molecular weight organic compound having at most 20 carbon atoms present in a trace amount in a cloth made of chemical fibers treated with a water and oil repellent agent, can be accurately analyzed.

### Solution to Problem

The present invention provides a process for analyzing a low molecular weight organic compound having at most 20 carbon atoms in a cloth made of chemical fibers treated with a water and oil repellent agent, which comprises the following steps:

(a) a step of dissolving the cloth made of chemical fibers treated with a water and oil repellent agent in a solvent capable of dissolving a resin constituting the cloth, to obtain a solution,

(b) a step of mixing the solution with a solvent capable of agglomerating the resin to agglomerate the resin, to obtain a liquid containing a resin agglomerate,

(c) a step of subjecting the liquid containing a resin agglomerate to solid-liquid separation to obtain a liquid phase, and

(d) a step of measuring the concentration of a low molecular weight compound having at most 20 carbon atoms in the liquid phase by means of a liquid chromatograph-mass spectrometer, a liquid chromatograph-tandem mass spectrometer, a gas chromatograph-mass spectrometer or a gas chromatograph-tandem mass spectrometer.

The analytical process of the present invention is suitable for a case wherein the water and oil repellent agent contains a fluoropolymer having repeating units based on a compound having a perfluoroalkyl group.

The solvent capable of dissolving the resin constituting the cloth made of chemical fibers preferably contains 1,1,1,6,6,6-hexafluoro-2-propanol.

The solvent capable of agglomerating the resin preferably contains an alcohol having from 1 to 5 carbon atoms.

The analytical process of the present invention is suitable for a case wherein the low molecular weight organic compound having at most 20 carbon atoms is a perfluorocarboxylic acid and/or a perfluorosulfonic acid and is more suitable for a case wherein the low molecular organic compound having at most 20 carbon atoms is PFOA and/or PFOS and/or PFOA precursors.

The analytical process of the present invention is more suitable for a case where the chemical fibers are polyester synthetic fibers, polyamide synthetic fibers such as nylon, acrylic synthetic fibers made of an acrylonitrile or acrylate as the main material, polyurethane synthetic fibers, cellulose semi-synthetic fibers or regenerated cellulose fibers.

Further, the analytical process of the present invention is applicable also to a case where the chemical fibers are made of a blended yarn with natural fibers.

### Advantageous Effects of Invention

According to the analytical process of the present invention, a low molecular weight organic compound having at most 20 carbon atoms in a cloth made of chemical fibers treated with a water and oil repellent agent can be accurately analyzed.

### BRIEF DESCRIPTION OF THE DRAWINGS

FIG. 1 shows the analytical results in Examples 3 to 6

FIG. 2 is a schematic diagram illustrating one embodiment of LC-MS/MS.

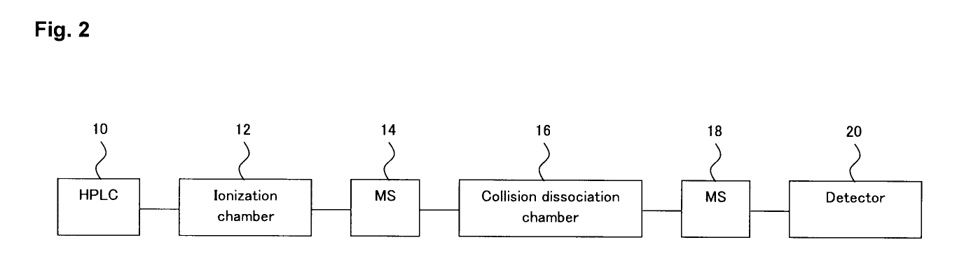

In FIG. 2, reference numeral 10 represents high performance liquid chromatograph (HPLC), 14 first mass spectrometer (MS), and 18 second mass spectrometer (MS).

### BEST MODE FOR CARRYING OUT THE INVENTION

In the present specification, a compound represented by the formula (I) will be referred to as a compound (1). Compounds represented by other formulae will be referred to in the same manner.

Further, in the present specification, a (meth)acrylate means an acrylate or a methacrylate.

### Water and Oil Repellent Agent

The water and oil repellent agent is usually used in a state of a water and oil repellent composition having the water and oil repellent agent dispersed or dissolved in a medium (a dispersion medium or solvent).

The water and oil repellent agent may, for example, be a fluorinated water and oil repellent agent or a silicone water and oil repellent agent. The analytical process of the present invention is suitable for a case where the water and oil repellent agent is a fluorinated water and oil repellent agent.

The fluorinated water and oil repellent agent is mainly one made of a fluoropolymer having repeating units based on a compound having a perfluoroalkyl group, or a fluoropolymer having repeating units based on a compound having a perfluoroalkyl group and repeating units based on a compound having a basic group.

The perfluoroalkyl group is a group having all of hydrogen atoms in an alkyl group substituted by fluorine atoms. The perfluoroalkyl group may have an etheric oxygen atom. Further, the perfluoroalkyl group may be bonded to an alkylene group having no fluorine atom.

The basic group is a group which can be ion-bonded to a protonic acid group.

The basic group may, for example, be —NR¹R², —N(O)R¹R², ═NR, —NR—, ═NH, —NH—, a piperidino group, a pyrrolidinyl group or a morpholino group. Here, each of R, R¹ and R² which are independent of one another, is a benzyl group, a C₁₋₈ alkyl or alkylene group, or a C₂₋₃ alkyl group having some of hydrogen atoms substituted by hydroxyl groups. Each of R¹ and R² is preferably a C₁₋₄ alkyl group.

The fluoropolymer may be a low molecular weight type or a high molecular weight type.

The low molecular weight type may, for example, be a fluorinated urethane compound or a fluorinated ester compound.

The fluorinated urethane compound is a reaction product of an alcohol having a perfluoroalkyl group with an isocyanate.

The fluorinated ester compound is a reaction product of an alcohol having a perfluoroalkyl group with a compound having an acid group (such as phosphoric acid or pyromellitic acid).

The high molecular weight type may, for example, be a fluorinated vinyl polymer.

The fluorinated vinyl polymer is preferably a copolymer of a (meth)acrylate having a perfluoroalkyl group. The (meth)acrylate having a perfluoroalkyl group is preferably a (meth)acrylate having a C₄₋₁₆ perfluoroalkyl group, more preferably a (meth)acrylate having a C₄₋₆ perfluoroalkyl group. Specifically, C₆F₁₃C₂H₄OCOCH═CH₂, C₆F₁₃C₂H₄OCOC(CH₃)═CH₂ or C₆F₁₃C₂H₄OCOCCl═CH₂ may be mentioned.

The following monomers may be mentioned as monomers to be copolymerized with the (meth)acrylate having a perfluoroalkyl group.

Vinyl chloride, vinylidene chloride, ethylene, vinylidene fluoride, vinyl acetate, vinyl propionate, vinyl isobutanoate, vinyl isodecanoate, vinyl stearate, cetyl vinyl ether, dodecyl vinyl ether, isobutyl vinyl ether, ethyl vinyl ether, 2-chloroethyl vinyl ether, styrene, α-methylstyrene, p-methylstyrene, chloromethylstyrene, methyl (meth)acrylate, butyl (meth)acrylate, 2-ethylhexyl (meth)acrylate, a (meth)acrylate having a C₁₂₋₂₄ alkyl group, 2-hydroxyethyl (meth)acrylate, cyclohexyl methacrylate, glycidylethyl methacrylate, 3-chloro-2-hydroxypropyl methacrylate, N-methylol (meth)acrylamide and N-butoxymethyl (meth)acrylamide.

A blocked compound of 2-isocyanateethyl methacrylate (the blocking agent is a compound reactive with an isocyanate, such as methyl ethyl ketoxime, butanone oxime, ε-caplolactone, pyrazole, 3-methylpyrazole or 3,5-dimethylpyrazole), a hexamethylene diisocyanate adduct of 3-phenoxy-2-hydroxypropyl acrylate, N,N-dimethyl (meth)acrylamide, diacetone (meth)acrylamide, vinyl alkyl ketone, butadiene, isoprene, chloroprene, benzyl (meth)acrylate, a (meth)acrylate having polysiloxane, allyl acetate, N-vinyl carbazole, maleimide, N-methyl maleimide, (meth)acrylic acid, glycerol mono(meth)acrylate, or hydroxypropyl (meth)acrylate.

An adduct of 2-hydroxyethyl methacrylate with E-caplolactone, polyethyleneoxide di(meth)acrylate, polyethyleneoxide-polypropyleneoxide-polyethyleneoxide di(meth)acrylate, propyleneoxide diglycidyl ether di(meth)acrylate, tripropyleneoxide diglycidyl ether di(meth)acrylate or diglycerol diglycidyl ether di(meth)acrylate.

A vinyl monomer having a basic group, such as N,N-dimethylamino (meth)acrylate, N,N-diethylamino (meth)acrylate, N,N-diisopropylamino (meth)acrylate, N-morpholino (meth)acrylate, N-piperidino (meth)acrylate, N,N-dimethylaminooxide (meth)acrylate or N,N-diethylaminooxide (meth)acrylate.

A monomer having an ammonium group, such as N,N,N-trimethyl-n-(2-hydroxy-3-methacryloyloxypropyl) ammonium chloride.

The water and oil repellent agent may contain two or more fluorinated polymers, or may contain a fluorinated polymer and another polymer. For example, the water and oil repellent agent may contain a fluorinated vinyl polymer and a fluorinated urethane compound, or may contain a fluorinated vinyl polymer and a polysiloxane.

The medium is preferably a medium containing water as the main component, and it may, for example, be water, or a mixed liquid of water with an organic solvent. The content of water in the medium is preferably at least 30 mass %, more preferably at least 50 mass %.

The organic solvent may, for example, be dipropylene glycol or tripropylene glycol.

### Cloth Made of Chemical Fibers

In the present invention, the chemical fibers may be synthetic fibers, semi-synthetic fibers or regenerated fibers, and specifically, they may, for example, be polyester synthetic fibers, polyamide synthetic fibers such as nylon, acrylic synthetic fibers made of an acrylonitrile or acrylate as the main material, polyurethane synthetic fibers, cellulose semi-synthetic fibers or regenerated cellulose fibers.

The polyester synthetic fibers may be ones made of polyethylene terephthalate, polytrimethylene terephthalate or polybutylene terephthalate. The nylon may, for example, be nylon 6 or nylon 66. The polyurethane synthetic fibers may, for example, be polyether type or polyester type synthetic fibers. The regenerated cellulose may, for example, be rayon or cellulose acetate.

The above chemical fibers may be composed of only one type, or may be made of a blended yarn of at least two types of fibers. Further, they may be ones made of a blended yarn of chemical fibers with natural fibers such as cotton, silk, wool or the like.

In the present invention, the cloth may be woven fabric or non-woven fabric. Further, there is no restriction in thickness, and it may, for example, be a carpet or the like.

The cloth made of chemical fibers treated with a water and oil repellent agent, is obtainable, for example, by dipping a cloth made of chemical fibers in a bath containing a water and oil repellent composition, followed by drying. The drying temperature is usually within a range of from 100 to 200° C.

### Analytical Process

By a process comprising the following steps, an analysis of a low molecular weight organic compound having at most 20 carbon atoms in a cloth made of chemical fibers treated with a water and oil repellent agent, is carried out:

(a) a step of dissolving the cloth made of chemical fibers treated with a water and oil repellent agent in a solvent (hereinafter referred to as a solvent for dissolution) capable of dissolving a resin constituting the cloth, to obtain a solution,

(b) a step of mixing the solution with a solvent (hereinafter referred to as a solvent for agglomeration) capable of agglomerating the resin to agglomerate the resin, to obtain a liquid containing a resin agglomerate,

(c) a step of subjecting the liquid containing a resin agglomerate to solid-liquid separation to obtain a liquid phase, and

(d) a step of measuring the concentration of a low molecular weight compound having at most 20 carbon atoms in the liquid phase by means of a liquid chromatograph-mass spectrometer (hereinafter referred to as LC-MS), a liquid chromatograph-tandem mass spectrometer (hereinafter referred to as LC-MS/MS), a gas chromatograph-mass spectrometer (hereinafter referred to as GC-MS) or a gas chromatograph-tandem mass spectrometer (hereinafter referred to as GC-MS/MS).

Step (a):

Step (a) is a step of dissolving the cloth made of chemical fibers treated with a water and oil repellent agent, in the solvent for dissolution thereby to elute a low molecular weight organic compound having at most 20 carbon atoms included in the interior of the fibers.

The solvent for dissolution may be a solvent which is capable of dissolving the resin constituting the cloth made of chemical fibers and the organic compound to be analyzed. In a case where the resin constituting the cloth is nylon, polyester or an acrylic resin, the solvent for dissolution may, for example, be a fluorinated solvent (excluding PFOA, PFOS and PFOA precursors to be analyzed), a strongly acidic solvent (such as formic acid or trifluoroacetic acid) or a high boiling point solvent (such as m-cresol or N,N-dimethylformamide). From such a viewpoint that a trouble in step (d) (such as an influence to the separation state in chromatograph or failure in removal of the solvent) is less likely to occur, a fluorinated solvent is preferred, and a C₁₋₄ fluorinated alcohol is more preferred. Further preferred is 2,2,2-trifluoroethanol, 2,2,3,3-tetrafluoro-1-propanol, 1,1,1,6,6,6-hexafluoro-2-propanol or 2,2,3,3,4,4,5,5-octafluoro-1-pentanol, and particularly preferred is 1,1,1,6,6,6-hexafluoro-2-propanol.

The amount of the solvent for dissolution is preferably from 100 to 5,000 parts by mass, more preferably from 500 to 3,000 parts by mass per 100 parts by mass of the cloth made of chemical fibers with a view to lowering the viscosity of the obtainable solution or to lowering the diluting ratio of the low molecular weight organic compound having at most 20 carbon atoms. Further, in a case where the solvent for dilution is a fluorinated solvent, a solvent mixture with a solvent other than the fluorinated solvent may be used as the solvent for dissolution. Such another solvent may be chloroform, dichloromethane, tetrahydrofuran, acetone or dimethylsulfoxide. In a case where the solvent mixture with another solvent is to be employed, the amount of such another solvent is preferably from 1 to 10,000 parts by mass, more preferably from 10 to 100 parts by mass per 100 parts by mass of the fluorinated solvent.

Step (b):

Step (b) is a step of mixing the solution obtained in step (a) with the solvent for agglomeration to obtain a liquid containing an agglomerate of the resin constituting the cloth made of chemical fibers.

The solvent for agglomeration may be a solvent which is capable of agglomerating the resin dissolved in the solvent for dissolution and capable of dissolving the organic compound to be analyzed, and it is preferably a solvent containing a C₁₋₅ alcohol (provided that a fluorinated alcohol is excluded), more preferably a solvent mixture of a C₁₋₅ alcohol with water. The C₁₋₅ alcohol may, for example, be methanol, ethanol, 1-propanol, 2-propanol, 1-butanol, 2-methyl-1-propanol, 2-butanol, 2-methyl-2-propanol, 1-pentanol, 3-methyl-1-butanol, 2-methyl-1-butanol, 2,2-dimethyl-1-propanol, 2-pentanol, 3-methyl-2-butanol, 3-pentanol or 2-methyl-2-butanol.

The amount of the solvent for agglomeration is preferably from 100 to 5,000 parts by mass, more preferably from 500 to 1,000 parts by mass per 100 parts by mass of the solution obtained in step (a) with a view to controlling the diluting ratio of the low molecular weight organic compound having at most 20 carbon atoms to be low.

Step (c):

Step (c) is a step of subjecting the liquid containing the resin agglomerate to solid-liquid separation to collect only the liquid phase.

The method for solid-liquid separation may, for example, be the following methods (c-1) to (c-3).

(c-1) A method wherein the liquid containing the resin agglomerate is left to stand still to have the resin agglomerate settled, whereupon the supernatant liquid (the liquid phase) is collected.

(c-2) A method wherein by means of a centrifugal separator, the liquid containing the liquid agglomerate is subjected to solid-liquid separation, whereupon the supernatant liquid (the liquid phase) is collected.

(c-3) A method wherein the liquid containing the resin agglomerate is subjected to filtration treatment, whereby the filtrate (the liquid phase) is collected.

The filter to be used for the filtration treatment is preferably a polyolefin filter or a cellulose filter. A fluororesin filter is not desirable, since it may contain a perfluorocarboxylic acid used as an emulsifier. The pore diameter of the filter is preferably at most 0.2 μm.

Step (d):

Step (d) is a step of measuring the concentration of a low molecular weight organic compound having at most 20 carbon atoms in the liquid phase obtained in step (c) by means of LC-MS, LC-MS/MS, GC-MS or GC-MS/MS.

In a case where the low molecular weight organic compound having at least 20 carbon atoms is a perfluorocarboxylic acid and/or a perfluoroalkane sulfonic acid, the apparatus for measuring its concentration is preferably LC-MS/MS from such a viewpoint that the specific compound can be analyzed highly selectively with high sensitivity. On the other hand, in a case where the low molecular weight organic compound having at most 20 carbon atoms is a precursor of PFOA, the apparatus for measuring its concentration is preferably GC-MS.

FIG. 2 is a schematic diagram illustrating one embodiment of LC-MS/MS. The particular LC-MS/MS comprises a high performance chromatograph 10 (HPLC) to separate the sample mixture (liquid phase) into the respective components, an ionizing chamber 12 to ionize the components separated by the high performance chromatograph 10. A first mass spectrometer 14 (MS) to select specific ions from ions formed in the ionizing chamber 12, a collision dissociation chamber 16 wherein argon or the like is collided with ions selected by the first mass spectrometer 14 to have the ions dissociated thereby to generate fresh ion groups, a second mass spectrometer 18 (MS) to analyze the ion groups generated in the collision dissociation chamber 16, and a detector 20.

The low molecular weight organic compound having at most 20 carbon atoms to be analyzed may be a perfluorocarboxylic acid, a perfluoroalkane sulfonic acid, a (perfluoroalkyl)ethyl alcohol, a (perfluoroalkyl)ethyl iodide, a (perfluoroalkyl)ethene or a perfluoroalkyl iodide.

As the perfluorocarboxylic acid, the compound (1) may be mentioned.

CₙF₂ₙ₊₁COOH (1)

wherein n is an integer of at least 1, preferably from 3 to 11.

The analytical process of the present invention is suitable for a case wherein the perfluorocarboxylic acid is PFOA (C₇F₁₅COOH) or a perfluorocarboxylic acid wherein the perfluoroalkyl group has at least 8 carbon atoms.

As the perfluoroalkane sulfonic acid, the compound (2) may be mentioned.

CₘF₂ₘ₊₁SO₃H (2)

wherein m is an integer of at least 1, preferably from 4 to 12.

The analytical process of the present invention is suitable for a case wherein the perfluorosulfonic acid is PFOS(C₈F₁₇SO₃H) or a perfluorosulfonic acid wherein the perfluoroalkyl group has at least 9 carbon atoms.

As the (perfluoroalkyl)ethyl alcohol, the compound (3) may be mentioned.

CₘF₂ₘ₊₁CH₂CH₂OH (3)

wherein m is an integer of at least 1, preferably from 4 to 12.

The analytical process of the present invention is suitable for a case wherein the (perfluoroalkyl)ethyl alcohol is perfluorooctylethyl alcohol (C₈F₁₇CH₂CH₂OH) or a (perfluoroalkyl)ethyl alcohol wherein the perfluoroalkyl group has at least 9 carbon atoms.

As the (perfluoroalkyl)ethyl iodide, the compound (4) may be mentioned.

CₘF₂ₘ₊₁CH₂CH₂I (4)

wherein m is an integer of at least 1, preferably from 4 to 12.

The analytical process of the present invention is suitable for a case wherein the (perfluoroalkyl)ethyl iodide is (perfluorooctyl)ethyl iodide (C₈F₁₇CH₂CH₂I) or a (perfluoroalkyl)ethyl iodide wherein the perfluoroalkyl group has at least 9 carbon atoms.

As the (perfluoroalkyl)ethene, the compound (5) may be mentioned.

CₘF₂ₘ₊₁CH═CH₂ (5)

wherein m is an integer of at least 1, preferably from 4 to 12.

The analytical process of the present invention is suitable for a case wherein the (perfluoroalkyl)ethene is (perfluorooctyl)ethene (C₈F₁₇CH═CH₂) or a (perfluoroalkyl)ethane wherein the perfluoroalkyl group has at least 9 carbon atoms.

As the perfluoroalkyl iodide, the compound (6) may be mentioned.

CₘF₂ₘ₊₁I (6)

wherein m is an integer of at least 1, preferably from 4 to 12.

The analytical process of the present invention is suitable for a case wherein the perfluoroalkyl iodide is perfluorooctyl iodide (C₈F₁₇I) or a perfluoroalkyl iodide wherein the perfluoroalkyl group has at least 9 carbon atoms.

According to the analytical process of the present invention as described above, a low molecular weight organic compound having at most 20 carbon atoms included in the interior of the fibers of the cloth made of chemical fibers treated with a water and oil repellent agent, is eluted by step (a), whereby PFOA, etc. remaining in the cloth treated with a water and oil repellent agent can be accurately quantitatively analyzed.

Further, the concentration of the low molecular weight organic compound having at most 20 carbon atoms can be measured by means of LC-MS, LC-MS/MS, GC-MS or GC-MS/MS in step (d) in a state where the resin constituting the cloth made of chemical fibers has been removed by steps (b) and (c). Therefore, the column of liquid chromatograph is free from clogging, or the injection inlet of gas chromatograph is free from soiling, whereby there is no substantial fluctuation in the concentration in every measurement.

Thus, it is possible to analyze with high precision the low molecular weight organic compound having at most 20 carbon atoms present in a trace amount in the cloth made of chemical fibers treated with a water and oil repellent agent.

### EXAMPLES

### Quantitative Determination of PFOA

Using the following LC-MS/MS, measurement (quantitative determination) of PFOA was carried out under the following measuring conditions. For calculation of the quantitative value, a standard addition method was used.

LC-MS/MS

HPLC: Nanospace Si-2, manufactured by Shiseido Co., Ltd.

MS/MS: TSQ Quantum Discovery MAX, manufactured by Thermo Fisher Scientific K.K.

HPLC Measuring Conditions

Column: Hypersil GOLD, manufactured by Thermo Fisher Scientific K.K., 2.1 mm×50 mm, 1.9 μm

Mobil phase: (Liquid A) 0.01 v/v % acetic acid aqueous solution, (liquid B) methanol for LC-MS

Gradient:

| Time (min) | 0 | 5 | 5.1 | 10 | 10.1 | 20 |
|---|---|---|---|---|---|---|
| B (%) | 60 | 60 | 100 | 100 | 60 | 60 |

Measurement completed in 10 minutes, followed by post run (stabilization) up to 20 minutes

Amount of sample injected: 5.0 μL

Flow rate: 200 L/min

Column temperature: 40° C.

MS Measuring Conditions

Ionization method: Negative ESI

Spray voltage: 1,500 V

Vaporizer temperature: 100° C.

Ion transfer tube temperature: 240° C.

Source CID: 0 V

Collision gas: Ar, 1.2 mTorr

Resolution (FWHM): 0.4 Da (unit resolution)

SRM monitor ion: 413.0→369.0

Collision Energy: 10 V

### Preparation Example 1

Into a glass beaker, 76.6 g of C₆F₁₃C₂H₄OCOC(CH₃)═CH₂, 13.5 g of stearyl acrylate, 4.1 g of a 3,5-dimethylpyrazole adduct of 2-isocyanatoethyl methacrylate, 25.9 g of a 10% aqueous solution of polyoxyethyleneoleyl ether (about 26 mol adduct of ethylene oxide) as an emulsifier, 5.2 g of a 10% aqueous solution of stearyl trimethyl ammonium chloride, 5.2 g of a 10% aqueous solution of ethylene oxide/propylene oxide polymer (containing 40% of ethylene oxide), 123 g of deionized water, 31.0 g of dipropylene glycol and 1.0 g of n-dodecylmercaptan were put and heated at 50° C. for 30 minutes, followed by mixing by means of a homomixer (Biomixer, manufactured by NIHONSEIKI KAISHA LTD.) to obtain a mixed liquid. While maintaining it at 50° C., the obtained mixed liquid was treated under 40 MPa by means of a high pressure emulsifier (Mini-lab, manufactured by APV Rannie) to obtain an emulsion. 300 g of the obtained emulsion was put into a stainless steel reactor, and 5.2 g of a 10% aqueous solution of dimethyl 2,2′-azobis[2-(2-imidazolin-2-yl propane) acetate as an initiator was added, followed by cooling to not higher than 30° C. The gas phase was substituted by nitrogen, and 9.3 g of vinyl chloride monomer was introduced, followed by a polymerization reaction for 15 hours at 65° C. with stirring to obtain an emulsion having a solid content concentration of 34.0 mass % (PFOA: less than the detection limit). To the emulsion, 1 ppm of PFOA was added, and then, the emulsion was diluted to 5% with water to obtain a water and oil repellent composition.

### Example 1

21.44 g of the water and oil repellent composition obtained in Preparation Example 1 was impregnated to 57.46 g of a nylon cloth (manufactured by Hiraoka Sangyo K.K.). The nylon cloth impregnated with the water and oil repellent composition was dried at 110° C. for 1.5 minutes and further heated at 170° C. for one minute to obtain a nylon cloth treated with a water and oil repellent agent.

The expected content (calculated value) of PFOA in the nylon cloth treated with a water and oil repellent agent is as follows.

Expected content (calculated value) of PFOA=1 (μg/g)×5(%)÷100×21.44 (g)÷57.46 (g)=18.7 (ng/g)

0.3 g of the nylon cloth treated with a water and oil repellent agent was sampled into a vial container. To the vial container, 3 mL of hexafluoroisopropanol was added to dissolve the nylon cloth thereby to obtain a solution.

The solution was added to 30 mL of a solvent mixture of methanol/pure water (1/1 by mass ratio) to have the resin agglomerated and precipitated thereby to obtain a liquid containing a resin agglomerate.

The liquid containing the resin agglomerate was left to stand still to have the resin agglomerate settled, whereupon the supernatant was, while filtrated through a chromatodisk having a pore diameter of 0.2 μm, collected into a vial for HPLC auto sampler, whereupon the concentration of PFOA in the sample liquid was measured by means of LC-MS/MS.

The above operation was carried out a total of three times. The results are shown in Table 2. The results of quantitative determination were close to the expected content.

TABLE 2

| | | PFOA quantitative |
|---|---|---|
| Nylon cloth | | value (ng/g) |
| Ex. 1 | First determination | 22.8 |
| | Second determination | 21.0 |
| | Third determination | 20.8 |

| | |
|---|---|
| Expected content | 18.7 |

### Example 2

A polyester cloth treated with a water and oil repellent agent was obtained and analyzed in the same manner as in Example 1 except that 13.38 g of the water and oil repellent composition obtained in Preparation Example 1 was impregnated to 13.54 g of polyester cloth. However, the measurement of the concentration of PFOA was carried out twice. The results are shown in Table 3.

The expected content (calculated value) of PFOA in the polyester cloth treated with a water and oil repellent agent is as follows.

Expected content (calculated value) of PFOA=1 (μg/g)×5(%)÷100×13.38 (g)÷13.54 (g)=49.4 (ng/g)

TABLE 3

| | | PFOA quantitative |
|---|---|---|
| Polyester cloth | | value (ng/g) |
| Ex. 2 | First determination | 48.6 |
| | Second determination | 57.4 |

| | |
|---|---|
| Expected content | 49.4 |

### Comparative Example 1

A nylon cloth treated with a water and oil repellent agent was obtained in the same manner as in Example 1.

3 g of the nylon cloth treated with the water and oil repellent agent was sampled into a vial container. To the vial container, 30 mL of ethanol was added, followed by shaking for two hours to carry out solid-liquid extraction.

The extracted liquid was diluted ten times with a solvent mixture of methanol/pure water (1/1 by mass ratio). The diluted liquid was, while filtrated through a chromatodisk having a pore diameter of 0.2 μm, collected into a vial for HPLC auto sampler, whereupon the concentration of PFOA in the sample liquid was measured by means of LC-MS/MS. The result is shown in Table 4. The result of quantitative determination was 10% of the expected content, and the analytical process of the present invention was superior.

TABLE 4

| | PFOA quantitative |
|---|---|
| Nylon cloth | value (ng/g) |
| Comp. Ex. 1 | 1.8 |
| Expected content | 18.7 |

### Comparative Example 2

A polyester cloth treated with a water and oil repellent agent was obtained in the same manner as in Example 2.

3 g of the polyester cloth treated with the water and oil repellent agent was sampled into a vial container. To the vial container, 30 mL of ethanol was added, followed by shaking for two hours to carry out solid-liquid extraction.

The extracted liquid was diluted ten times with a solvent mixture of methanol/pure water (1/1 by mass ratio). The diluted liquid was, while filtrated through a chromatodisk having a pore diameter of 0.2 μm, collected into a vial for HPLC auto sampler, whereupon the concentration of PFOA in the sample liquid was measured by means of LC-MS/MS. The result is shown in Table 5. The result of quantitative determination was 10% of the expected content, and the analytical process of the present invention was superior.

TABLE 5

| | PFOA quantitative |
|---|---|
| Polyester cloth | value (ng/g) |
| Comp. Ex. 2 | 9.9 |
| Expected content | 49.4 |

### Examples 3 to 6

21.44 g of the water and oil repellent composition obtained in Preparation Example 1 was impregnated to 57.46 g of nylon cloth (manufactured by Hiraoka Sangyo K.K.). The nylon cloth impregnated with the water and oil repellent composition was dried at 110° C. for 1.5 minutes (Example 3).

The nylon cloth obtained in Example 3 was further heated at 130° C. for one minutes (Example 4), the nylon cloth obtained in Example 3 was further heated at 150° C. for one minutes (Example 5), or the nylon cloth obtained in Example 3 was further heated at 170° C. for one minutes (Example 6).

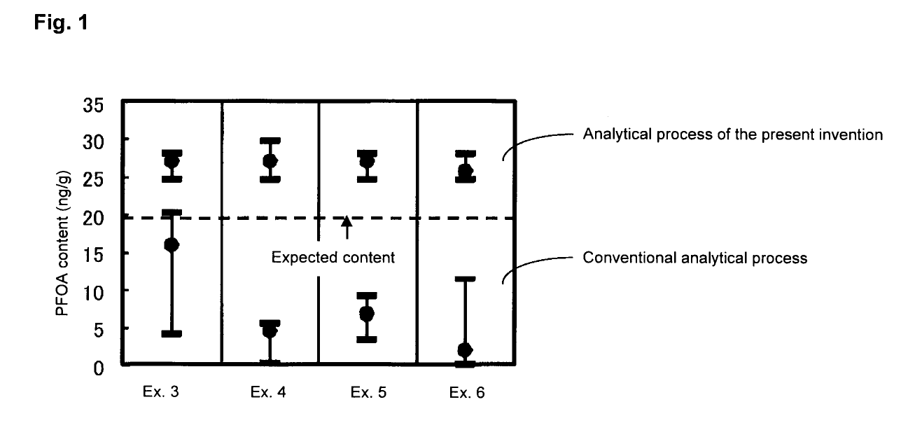

With respect to such 4 types of nylon cloth, the concentration of PFOA was measured in the same analytical method as in Example 1 and Comparative Example 1. The results are shown in FIG. 1 wherein the upper limit value and the lower limit value in the measurements of three times are represented by bar lines, and the average value is represented by a circular symbol. It was found that by the conventional process in accordance with Comparative Example 1, the fluctuation was substantial, and the quantitative value tended to be low as the heating temperature became high. The analytical process of the present invention in accordance with Example 1 was superior in that constant results in quantitative determination were obtained without being influenced by the heating temperature after the drying.

### INDUSTRIAL APPLICABILITY

The analytical process of the present invention is useful as a process for analyzing a low molecular weight organic compound having at most 20 carbon atoms in a cloth made of chemical fibers treated with a water and oil repellent agent.

The entire disclosure of Japanese Patent Application No. 2008-171204 filed on Jun. 30, 2008 including specification, claims, drawings and summary is incorporated herein by reference in its entirety.

What is claimed is:

1. A process for analyzing a low molecular weight organic compound having at most 20 carbon atoms in a cloth made of chemical fibers treated with a water and oil repellent agent, which comprises the following steps:
(a) a step of dissolving the cloth made of chemical fibers treated with a water and oil repellent agent in a solvent capable of dissolving a resin constituting the cloth, to obtain a solution,
(b) a step of mixing the solution with a solvent capable of agglomerating the resin to agglomerate the resin, to obtain a liquid containing a resin agglomerate,
(c) a step of subjecting the liquid containing a resin agglomerate to solid-liquid separation to obtain a liquid phase, and
(d) a step of measuring the concentration of a low molecular weight compound having at most 20 carbon atoms in the liquid phase by means of a liquid chromatograph-mass spectrometer, a liquid chromatograph-tandem mass spectrometer, a gas chromatograph-mass spectrometer or a gas chromatograph-tandem mass spectrometer.

2. The process for analyzing a low molecular weight organic compound having at most 20 carbon atoms in a cloth made of chemical fibers treated with a water and oil repellent agent according to claim 1, wherein the water and oil repellent agent contains a fluoropolymer having repeating units based on a compound having a perfluoroalkyl group.

3. The process for analyzing a low molecular weight organic compound having at most 20 carbon atoms in a cloth made of chemical fibers treated with a water and oil repellent agent according to claim 1, wherein the solvent capable of dissolving a resin constituting the cloth made of chemical fibers contains 1,1,1,6,6,6-hexafluoro-2-propanol.

4. The process for analyzing a low molecular weight organic compound having at most 20 carbon atoms in a cloth made of chemical fibers treated with a water and oil repellent agent according to claim 1, wherein the solvent capable of agglomerating the resin contains an alcohol having from 1 to 5 carbon atoms.

5. The process for analyzing a low molecular weight organic compound having at most 20 carbon atoms in a cloth made of chemical fibers treated with a water and oil repellent agent according to claim 1, wherein the low molecular weight organic compound having at most 20 carbon atoms is a perfluorocarboxylic acid or a perfluoroalkane sulfonic acid.

6. The process for analyzing a low molecular weight organic compound having at most 20 carbon atoms in a cloth made of chemical fibers treated with a water and oil repellent agent according to claim 1, wherein the low molecular weight organic compound having at most 20 carbon atoms is a (perfluoroalkyl)ethyl alcohol, a (perfluoroalkyl)ethyl iodide, a (perfluoroalkyl)ethene or a perfluoroalkyl iodide.

7. The process for analyzing a low molecular weight organic compound having at most 20 carbon atoms in a cloth made of chemical fibers treated with a water and oil repellent agent according to claim 1, wherein the chemical fibers are polyester synthetic fibers, polyamide synthetic fibers such as nylon, acrylic synthetic fibers made of an acrylonitrile or acrylate as the main material, polyurethane synthetic fibers, cellulose semi-synthetic fibers or regenerated cellulose fibers.

8. The process for analyzing a low molecular weight organic compound having at most 20 carbon atoms in a cloth made of chemical fibers treated with a water and oil repellent agent according to claim 1, wherein the chemical fibers are made of a blended yarn with natural fibers.
